(19) United States
(12) Patent Application Publication
(10) Pub. No.: US 2008/0196188 A1
(43) Pub. Date: Aug. 21, 2008

(54) Fibrous Composite that is Dissoluble or Decomposable in Water, and Products Manufactured Thereform

(75) Inventors: Konrad Brunner, Kelheim (DE); Friedrich Herbig, Regensburg (DE); Walter Roggenstein, Bad Abbach (DE); Stefan Sulzmaier, Bad Abbach (DE)

Correspondence Address: HOWSON AND HOWSON, SUITE 210, 501 OFFICE CENTER DRIVE, FT WASHINGTON, PA, 19034, US

(73) Assignee: KELHEIM FIBRES GMBH, Kelheim/Donau (DE)

(21) Appl. No.: 11/917,531

(22) PCT Filed: Jun. 14, 2006
(86) PCT No.: PCT/EP2006/063224

§ 371 Date: Jan. 3, 2008

(30) Foreign Application Priority Data
Jun. 15, 2005 (DE) 10 2005 027 795.0
Jun. 23, 2005 (DE) 10 2005 029 597.5

(51) Int. Cl. A47L 13/16; B32B 5/22; B32B 7/02; D04H 11/00; D04H 1/40

(52) U.S. Cl. 15/210.1; 428/292.1; 428/219; 442/335; 28/103

(57) ABSTRACT

The present invention relates to a fibrous composite comprising or consisting of natural and/or synthetic fibres, characterised in that at least some of the fibres of the composite exhibit a flat cross-section and the fibrous composite is readily decomposable or dissoluble in water or other liquid.

The present invention relates to a fibrous composite comprising or consisting of natural and/or synthetic fibres, wherein at least some of the fibres of the composite exhibit a flat cross-section and the fibrous composite is readily decomposable or dissoluble in water and other liquid. The invention also relates to products manufactured from said fibrous composite or comprising said fibrous composite, and also to a process for producing such a fibrous composite. The invention also relates, in particular, to the use of fibres with flat cross-section for the purpose of improving the decomposition properties or dissolution properties in water or other liquid of a fibrous composite containing these fibres.

### STATE OF THE ART

Throw-away articles or single-use articles, such as, for example, moist cloths for baby care or personal hygiene, babies' nappies, feminine-hygiene products etc., are distinguished, in general, by a soft and often absorbent surface and also by high elasticity and strength, as well as structural integrity even in the presence of moisture, so that they are able to serve their purpose without breaking up in the process. For example, fibrous-composite fabrics (fleece fabrics) that contain the chemical fibres polyester or polypropylene and viscose may exhibit these material properties.

Known polymer materials of such a type, however, have the disadvantage that composite structures manufactured therefrom do not decompose in water or do not decompose sufficiently in water. Consequently they have to be disposed of via the normal household refuse and cannot be disposed of via ordinary domestic sewerage systems, for example by being flushed away in the toilet. Especially in countries in which the pipelines have been laid with a narrow bore, for example in Italy, pipe blockages due to insoluble materials or insufficiently soluble materials that get into the system cause great problems.

A simplified disposal via the sewerage system and also an overall improved biodegradability of polymer materials that can be used, in particular, for personal-hygiene products, such as fleece cloths and other non-woven structures, are desirable. The fibrous-composite structures of the materials are to decompose or dissolve already in the sewer to such an extent that they are no longer recognisable in the sewage-treatment plant.

Publications are known in which temperature-sensitive or ion-sensitive compositions are described for materials that are capable of being dispersed or flushed away in water. For instance, DE 102 91 388 T1 describes polymers that are dispersible in water, processes for the production thereof, and objects in which they are used. The problematical nature of the disposability of single-use articles such as nappies, moistened wipes etc. is also described in said document. In order to obtain the desired dispersability of the articles in cold water, a composition is proposed that comprises sodium polyacrylate and a styrene emulsion.

The method described in EP 1 138 823 B1 for disposing of fleece structures in the sewerage system without any problems consists in using fibre mixtures having a defined fibre-length distribution. The fibre mixtures consist substantially of fibres with a maximal fibre length of 10 mm, and also of a proportion of microfibres with a maximal fibre length of 1 mm. As a result of the microfibres being dissolved out in the presence of water, the fleece structure is decomposed.

In EP 1 044 104 B1 the object as formulated is achieved through the use of a polymer that is decomposable in water or biologically as an integral part of the fleece structure. As a result of the dissolution of this specific polymer layer in the waste-disposal system, the fleece decomposes into smaller constituents. For many end uses, however, these compositions do not exhibit the desired properties with regard to water absorbency, strength, decomposability, biodegradability or such like.

### Formulation of the Object

An object of the present invention consists in making available a fibrous composite and, in particular, a polymer material or a polymer mixture in filamentary form or fleece form, the fibrous composite being sufficiently dissoluble in water, particularly in flowing water, and consequently capable of being flushed away, and at the same time exhibiting a strength and elasticity necessary for its intended use, even in the presence of moisture.

This object is achieved by means of a fibrous composite comprising or consisting of natural and/or synthetic fibres, characterised in that at least some of the fibres of the composite exhibit a flat cross-section and the fibrous composite is readily decomposable or dissoluble in water or other liquid.

The term ‘fibrous composite’ in the context of this application is to be understood to mean a composite of several single fibres. In this connection, the fibrous composite may consist of single fibres of more than one type of the same fibrous material (e.g. flat fibre and round fibre) and/or of fibres made of differing fibrous material. In contrast with, for example, textile structures that exhibit regular filamentary structures, a fibrous composite preferably does not have a regular structure. The term ‘flat fibres’ in the context of this application is to be understood to mean fibres, the cross-section of which perpendicular to the longitudinal axis of the respective fibre exhibits an aspect ratio of at least 1:2.

The expression ‘readily decomposable or dissoluble in water or other liquid’ in the context of this application is to be understood to mean a fibrous composite that displays macroscopically discernible, distinct dissolution phenomena after the following number of turns in the ‘flushability test’ described below (on this point, see also FIG. 2): 12 turns, preferably 10 turns, again in each instance preferably 9, 8, 7 and 6 turns, and, quite particularly preferably, 5 turns. The ‘flushability test’ for appraising the decomposability or dissolubility of the fibrous composite simulates the mechanical loading in the effluent system. To this end, a plastic pipe, sealed at one end, with an inside diameter of 100 mm and with a length of 1000 mm is filled with water, so that a water column measuring 330 mm results. A sample of the fibrous composite to be examined is prepared to dimensions MD 220 mm and CD 110 mm (MD=machine direction, longitudinal direction; and CD=cross direction, transverse direction) and is put into the water-filled pipe. The centrally supported and rotatable plastic pipe is sealed by means of a screwable cap. By turning the pipe about 180 degrees in each instance, a toilet flush is simulated. The turns are performed until such time as a distinct opening in the fleece bond, with partial formation of cracks and holes, can be discerned; see FIG. 2. The number of 180-degree turns constitutes the result of measurement.

This test is preferably used for the decomposability of non-woven structures.

The fibrous material of the fibrous composite according to the invention is, in particular, a polymer material that contains natural and/or synthetic fibres, preferably viscose fibres. In a particularly preferred variant, some of the fibrous material is itself soluble in water.

Viscose fibres or polymer fibres that are conventionally used exhibit an approximately circular or round cross-section. In contrast, the fibres that are used in connection with the present invention exhibit a changed cross-section, in particular a flat, preferably largely rectangular and/or trapezoidal cross-section perpendicular to the longitudinal axis of the fibre. The individual fibres consequently have a tape-like shape.

The flat fibres that are used in accordance with the invention may preferably additionally exhibit a crenellated (battlement-like) surface. A surface structure of such a type enlarges the surface area of the fibres and intensifies the capacity thereof to absorb moisture. The absorbency of the end products is thereby increased in comparison with fibres having a smooth surface. The flat fibres are preferably cellulosic fibres, particularly preferably viscose fibres.

The advantageous effect that has been detected in the course of use of the flat fibres that have been described in the fibrous composite according to the invention is the greatly improved dissolubility or decomposability of the fibrous composite in water or other liquids, having the result in practice that fibrous composites of such a type, or articles produced therefrom as universal cleansing and grooming articles, can be used which can be disposed oft without appreciable restrictions, via conventional domestic sewerage systems. This is designated as so-called ‘flushability’ (see above), since the fleece fabrics can be flushed away via the toilet, and cause neither blockages nor any other problems in the sewerage systems and sewage-treatment plants. By reason of the diminished adhesion of the flat fibres to one another and to the round fibres additionally contained in the fleece material, and/or by reason of the looser fibrous composite, the fibrous composite dissolves in the liquid distinctly more rapidly and is decomposed there in sufficiently short time into sufficiently small composite parts.

The fibrous composite according to the invention preferably constitutes a non-woven fleece or a thread. Particularly preferred in this connection is a fibrous composite according to the invention that is characterised by a mixture of fibrous materials.

The fibres of the fibrous composite according to the invention, which in particular may contain polymer fibres, polyester fibres, polypropylene fibres, viscose fibres and/or cellulose fibres, may be processed, mingled with other fibres—for example, with polyester fibres and/or polyethylene fibres in varying mixing ratios—so as to form known structures. In particular, material mixtures of such a type may be processed into fibrous composite fabrics. As such, they find application, dry or moistened, for baby care or personal hygiene, in the domestic field or for other purposes. Usability of materials according to the invention of such a type in the hygienic or medical field (for example, menstrual hygiene, wound-dressings, etc.) likewise obtains. The industrial applicability of such fibrous composite fabrics is also advantageous.

In practice, the proportion of the flat fibres with respect to the entire fibrous material may, as a matter of principle, be between 1 wt. % and approximately 100 wt. %, with the proportion of the flat fibres amounting typically to between 10 wt. % and 90 wt. %. Good properties may be obtained, in particular, with a proportion of the flat fibres between 20 wt. % and 80 wt. %, preferentially between 30 wt. % and 70 wt. %.

Particularly advantageous properties are exhibited by a fibrous composite according to the invention which is a polymer mixture that consists of polyester flat fibres (in particular, PET) in a proportion amounting to 40 wt. %, and of viscose flat fibres in a proportion amounting to 60 wt. %. The viscose fibres impart softness and absorbency to the fleece structure, whereas the polyester flat fibres are responsible, in particular, for the necessary strength.

The fineness of the flat fibres that are used in the fibrous composite, particularly in fleeces, may typically amount to between 0.9 dtex and 9.0 dtex, with the fineness in the case of a fleece according to the invention preferentially amounting to between 1.5 dtex and 3.0 dtex.

The cut length of the flat fibres that are used in the fibrous composite according to the invention may typically amount to between 4 mm and 75 mm, whereby the cut length in the case of a fleece fabric according to the invention may preferentially amount to between 20 mm and 50 mm.

The specific weight of the fibrous composite according to the invention or of the flat fibres that are used in said fibrous composite may typically amount to between 10 g/m² and 500 g/m², whereby the specific weight in the case of a fibrous composite according to the invention, particularly in the form of fleece, preferentially amounts to between 40 g/m² and 150 g/m². Particularly preferred in this connection is a specific weight between 50 g/m² and 150 g/m².

In laboratory tests, a non-woven or a structure produced in the so-called paper process, which contained or constituted a fibrous composite according to the invention, displayed a distinctly higher rate of dissolution in water than reference structures with conventional viscose fibres with circular cross-section. At the same time, neither in the dry state nor in the moist state could a significant decrease in the structural strength be detected, compared to conventional reference structures. In comparison with round viscose fibres or with fibrous composite fabrics exhibiting round viscose fibres, the viscose fibres or flat fibres according to the invention or fibrous composite fabrics exhibiting viscose fibres or flat fibres according to the invention exhibit higher flexibility and softness.

The factors constituted by moisture behaviour and absorbency, which are likewise important in application, particularly in the mixture with other fibres, are just as outstanding for the flat fibres according to the invention that are employed, as for known generic fibres.

Depending on the type and proportion of pigment, the fibres may appear glossy, delustred or coloured.

The process for producing fibrous composites according to the invention with viscose fibres or flat fibres corresponds to the known production process for fibrous composites and fibrous-composite fabrics with conventional, round viscose fibres. Conventional technologies are, for example but not exclusively, hydroentanglement, air-laid processes or fleece needling. The technology is known and proven in practice, so the production of the novel fibrous composites according to the invention and of the articles formed therefrom is greatly simplified.

The fibrous-composite material according to the invention is completely biodegradable and is certifiable in accordance with Ökotex Standard Stage 1, to the extent that use is made exclusively of cellulosic fibres, in particular viscose fibres.

Also a part of the invention is to produce from the fibrous composites according to the invention, or by using them, articles (intermediate products or end products) for defined uses. These include fleece fabrics and fibre substrates, wiping cloths that are capable of being used in the home and/or for cleansing, absorbent fleece cloths, hygienic cloths or baby cloths and/or personal-hygiene cloths. Articles for technical application may also be produced from the fibrous composite according to the invention or by using it. Such articles include, for example, a technical fleece fabric or technical fleece material and a filter fabric or filter material.

A particularly preferred article according to the invention is a cloth for various applications that comprises at least two layers, one of the layers consisting substantially of a fibrous composite according to the invention. Thus for defined applications there is, for example, a particularly readily dissoluble layer, whereas the other layer—if this is desired—is less readily dissoluble or decomposable than the fibrous composite according to the invention. However, it is preferred that the further layers are also likewise readily decomposable or dissoluble, at least with regard to their structure. In this context it is quite particularly preferred that at least one further layer consists of cellulose-fibre pulp.

The combination of a layer made of fibrous composite according to the invention and a further layer made of cellulose pulp so as to form cloths has the result that cloths are produced that are provided with good flushability (i.e. the fibrous-composite structures thereof dissolve sufficiently and well in sewerage systems). At the same time, such cloths possess a rough side (cellulose pulp) with corresponding wiping properties and suction properties, and a soft side with properties differing from those of the rough side. Thus the rough side may—for example, in the case where it is being employed as a grooming cloth in baby care—be used for absorbing coarse pollutants, whereas the soft side, which comprises the fibrous composite according to the invention, can be used for fine cleansing with a lot of skin contact.

Also an integral part of the invention is the use of fibres with a flat cross-section for the purpose of improving the decomposition properties or dissolution properties in water or other liquid of a fibrous composite containing these fibres.

A use according to the invention of flat fibres, in particular viscose flat fibres in the textile industry, also in combination with other than the stated materials and in other structures (for example, yarns, woven fabric, knitted fabric etc.), is conceivable.

Also an integral part of the invention is the production of a fibrous composite according to the invention, comprising the following steps:

a) providing flat fibres,

b) optionally, providing further fibres and

c) connecting the fibres to form a fibrous composite, so that the composite is readily decomposable or dissoluble in water or other liquid.

### EXEMPLARY EMBODIMENTS

The invention will be elucidated in more detail in the following on the basis of preferred exemplary embodiments with reference to the appended Figures.

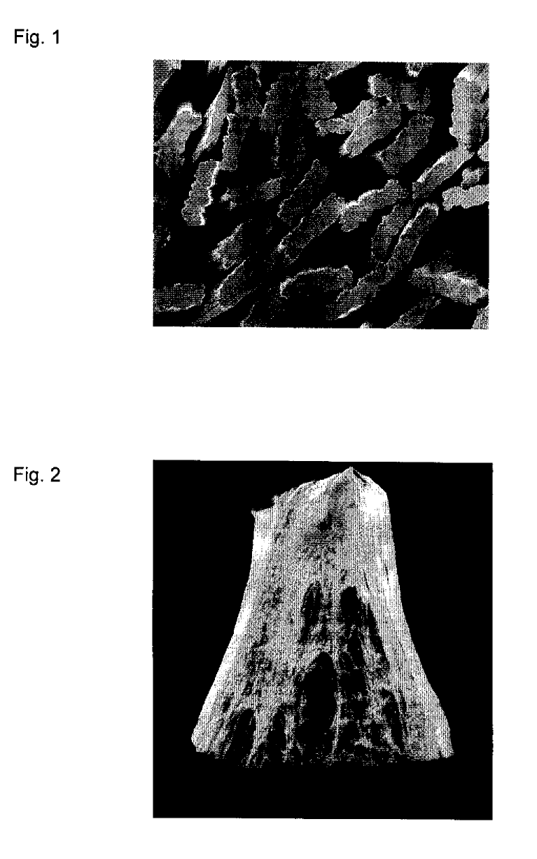

FIG. 1 shows an enlarged cross-section of the fibre structure of a fibrous composite according to the invention. The individual viscose fibres or flat fibres are visible here, and it becomes clear that these extend in tape-like manner. Their cross-section perpendicular to the longitudinal axis of the fibre is flat. The surfaces of the individual viscose fibres exhibit elongated grooves, in each instance in the longitudinal direction, so that the cross-section of the individual fibre does not exhibit a smooth edge contour but rather exhibits a crenellated (battlement-like) edge contour.

FIG. 2 illustrates the beginning of a decomposing fibrous-composite structure, here a fleece structure.

### EXAMPLE 1

From a viscose flat fibre with a fibre fineness of 2.4 dtex and with a fibre length of 38 mm a fleece structure with a weight per unit area of 50 g/m² was produced by means of a hydroneedling plant corresponding to the state of the art at a water pressure of 50 bar and at a transport speed of 70 m/min. In the course of a flushability test, carried out in accordance with the description, a decomposition of fleece was observed after only 7 revolutions. Tensile strengths of MD Dry 41,8 N/Scm and CD Dry of 12,9 N/Scm were measured. A comparable fleece structure made of a viscose fibre with approximately circular cross-section, with a fibre fineness of 1.7 dtex and with a cut length of 38 mm, produced with a hydroneedling plant corresponding to the state of the art at a water pressure of 50 bar and at a transport speed of 50 m/min, displayed in the case of a weight per unit area of 50 g/m² a first decomposition of fleece only after 12 turns.

### EXAMPLE 2

A viscose flat fibre with a fibre fineness of 2.4 dtex and with a cut length of 38 mm was processed as described in Example 1 with a water pressure of 50 bar and with a transport speed of 100 m/min so as to form a fleece structure with a weight per unit area of 50 g/m². The first decomposition of fleece, in accordance with the flushability test method that has been described, was observed after just 5 turns.

### EXAMPLE 3

In the case of a fleece structure, produced in a process comparable to Examples 1 and 2 using a viscose flat fibre with a fibre fineness of 2.4 dtex and with a cut length of 38 mm in a 50%/50% mixture with a viscose fibre, with approximately circular cross-section, with a fibre fineness of 1.7 dtex and with a cut length of 38 mm, the first decomposition of fleece, according to the flushability test that has been described, was detected after 7 turns.

### EXAMPLE 4

In the test process that has been described, a fleece structure consisting of the viscose flat fibre described in Example 1 with a proportion by weight, with respect to the total fleece, of 65% as a first layer and with cellulosic pulp material with a proportion by weight, with respect to the total fleece, of 35% as a second layer, displayed a first dissolution of fleece after 10 turns. The layers had been connected by hydroentanglement.

1. Fibrous composite comprising or consisting of natural and/or synthetic fibres, characterised in that at least some of the fibres of the composite exhibit a flat cross-section wherein the fibres having a flat cross-section are characterised by a cut length between 4 mm and 75 mm, preferably between 20 mm and 50 mm and the fibrous composite is readily decomposable or dissoluble in water or other liquid.

2. Fibrous composite according to claim 1, characterised by a rectangular and/or trapezoidal cross-section of at least some of the fibres.

3. Fibrous composite according to claim 1, comprising or consisting of viscose fibres and/or cellulose fibres.

4. Fibrous composite according to claim 1, comprising or consisting of polymer fibres, in particular polyester fibres and/or polypropylene fibres.

5. Fibrous composite according to claim 1, characterised in that it is a non-woven fleece or a thread.

6. Fibrous composite according to claim 1, characterised by a mixture of various fibrous materials.

7. Fibrous composite according to claim 1, characterised by a fineness of the flat fibres between 0.9 dtex and 9.0 dtex, preferably between 1.5 dtex and 3.0 dtex.

8. (canceled)

9. Fibrous composite according to claim 1, characterised by a width/length ratio of the lateral edges of a cross-section of the flat fibres between 1:2 and 1:20, preferably between 1:4 and 1:8.

10. Fibrous composite according to claim 1, characterised by a specific weight between 10 g/m² and 500 g/m², preferably between 40 g/m² and 150 g/m².

11. Fibrous composite according to claim 1, characterised by a proportion of the flat fibres between 1 wt. % and 100 wt. %, preferably between 10 wt. % and 90 wt. %.

12. Fleece material or fibre substrate consisting of or comprising a fibrous composite according to claim 1.

13. Wiping cloth that is capable of being used in the home and/or for cleansing, absorbent fleece cloth, hygienic cloth or baby cloth and/or personal-hygiene cloth, consisting of or comprising a fibrous composite according to claim 1.

14. Technical fleece fabric or technical fleece material or filter fabric or filter material, consisting of or comprising a fibrous composite according to claim 1.

15. Cloth according to claim 13, comprising at least two layers, one of the layers consisting substantially of a fibrous composite according to claim 1.

16. Cloth according to claim 15, wherein the further layer or layers are likewise readily decomposable or dissoluble.

17. Cloth according to claim 16, wherein at least one further layer of pulp consists of cellulose fibres.

18. Use of fibres with a flat cross-section and being characterised by a cut length between 4 mm and 75 mm, preferably between 20 mm and 50 mm for the purpose of improving the decomposition properties or dissolution properties in water or other liquid of a fibrous composite containing these fibres.

19. Process for producing a fibrous composite according to claim 1, comprising the following steps:
a) providing flat fibres characterised by a cut length between 4 mm and 75 mm, preferably between 20 mm and 50 mm,
b) optionally, providing further fibres and
c) connecting the fibres to form a fibrous composite, so that the composite is readily decomposable or dissoluble in water or other liquid.
